(19) United States
(12) Patent Application Publication
(10) Pub. No.: US 2024/0426974 A1
(43) Pub. Date: Dec. 26, 2024

(54) Harmonic Radar Scanner for Electronics

(71) Applicant: THE TRUSTEES OF DARTMOUTH COLLEGE, Hanover, NH (US)

(72) Inventors: Beatrice Perez, Hanover, NH (US); Timothy Pierson, Hanover, NH (US); Gregory Mazzaro, Hanover, NH (US); David Kotz, Hanover, NH (US)

(21) Appl. No.: 18/749,826

(22) Filed: Jun. 21, 2024

Related U.S. Application Data
(60) Provisional application No. 63/522,236, filed on Jun. 21, 2023.

(51) Int. Cl. G01S 7/28; G01S 13/04; G01S 13/76

(52) U.S. Cl. CPC G01S 7/2813; G01S 13/04; G01S 13/76

(57) ABSTRACT

A harmonic radar system for detecting an electronic device includes a signal generator for generating one or more transmit radio frequency (RF) signals, a transmitting antenna for sending the transmit RF signals into an environment, a receiving antenna for receiving signals reflected or re-radiated by the electronic device in the environment in response to the transmit RF signals, and a spectrum analyzer for identifying a harmonic frequency of the transmit RF signals in the filtered signals.

### CROSS-REFERENCE TO RELATED APPLICATIONS

This application claims the benefit of U.S. Provisional Application No. 63/522,236, filed on 21 Jun. 2023, the disclosure of which is incorporated herein by reference in its entirety.

### GOVERNMENT RIGHTS

This invention was made with government support under grants 1955805 and 2030859 awarded by the National Science Foundation. The government has certain rights in the invention.

### BACKGROUND

Data about users of electronic devices is collected almost continually by phones, cameras, Internet websites, and other electronic devices. The advent of so-called ‘Smart Things’ or the Internet of Things (IoT) now enables ever-more sensitive data to be collected in an increasing number of places, including inside a user's home.

While smart devices are becoming a common fixture in many different environments, their presence may not be readily apparent. One way to increase users' control of their information is to alert them to the presence of potentially unwanted electronics in their environment. For example, a user may want to detect devices within the home or in another location, such as a hotel or rental property. In addition, a user may want to locate a misplaced device, or a device placed surreptitiously be another.

### SUMMARY OF THE INVENTION

In an embodiment, a harmonic radar system for detecting an electronic device includes a signal generator that generates one or more transmit radio frequency (RF) signals, a transmitting antenna for sending the transmit RF signals into an environment, a receiving antenna for receiving signals re-radiated by the electronic device in the environment in response to the transmit RF signals, and a spectrum analyzer for identifying a harmonic frequency of the transmit RF signals in the filtered signals.

In another embodiment, a harmonic radar system for detecting an electronic device including a signal generator that generates a transmit radio frequency (RF) signal, a coupler for receiving the transmit RF signal, an antenna for (i) transmitting the transmit RF signal from the coupler into an environment including the electronic device and (ii) receiving signals re-radiated by the electronic device in response to the transmit RF signals and sending them to the coupler, and a spectrum analyzer for identifying a harmonic frequency of the transmit RF signals in the received signals.

A method of using a harmonic radar system for detecting an electronic device includes generating a transmit radio frequency (RF) signal, transmitting the transmit RF signal into an environment including the electronic device, receiving a signal re-radiated by the electronic device in response to the transmit RF signal, removing environmental and system-generated noise from received signal, and identifying a harmonic frequency of the transmit RF signal in the received signal.

### BRIEF DESCRIPTION OF THE FIGURES

FIG. 1 is a schematic diagram of the behavior of radio signals when encountering nonlinear circuits.

FIG. 2 is a block diagram of a wireless configuration of a harmonic radar system for detecting an electronic device, in an embodiment.

FIG. 3 is a block diagram of a wired configuration of a harmonic radar system for detecting electronic devices, in an embodiment.

FIG. 4 is a block diagram of another harmonic radar system for detecting an electronic device, in an embodiment.

FIG. 5 illustrates an algorithmic description of method for detecting an electronic device using a harmonic radar system, in an embodiment.

FIG. 6 is a block diagram of a harmonic radar system for detecting an electronic device, in an embodiment.

FIG. 7 is a graph showing a representative harmonic response of a device to a series of single tone pulses, in an embodiment.

FIG. 8 is a graph showing a representative harmonic response of a device to a series of swept range of tones, in an embodiment.

FIG. 9 is a graph showing a representative harmonic response of a device to simultaneous tones, in an embodiment.

### DETAILED DESCRIPTION OF THE EMBODIMENTS

So-called “smart” consumer electronics (e.g., devices that have computational and communication capabilities) are becoming fully integrated into the daily lives or many users. Many smart devices, also referred to as Internet of Things (IoT) devices are becoming a common fixture in homes—and yet their presence may not be readily apparent. For example, in many homes today, smart assistants such as Amazon Echo™ or Google Home™, are easy to spot, but other smart devices are more difficult to visually detect, such as smart light bulbs, smart door locks, or smart refrigerators. Many of these devices have traditionally lacked computational and communications capabilities, and the smart versions may be easily mistaken for their traditional “dumb” counterparts. Other devices, such as surveillance cameras and microphones, may be purposefully located in concealed or obscured locations to inconspicuously collect data. Furthermore, the number of commercially available smart home devices grows every day, and research suggests the number of devices in a home or other location may grow exponentially over the coming years. In the near future, any given location could easily contain dozens or hundreds of smart devices. The ubiquity of these devices will make it difficult to discover all of the devices present in an environment.

One scenario in which an environment may include unknown electronic devices is when a home is sold. While the previous homeowner will remove many smart devices, some may be left behind, such as a smart thermostat. Research has shown that a surprising amount of information about the behavior of a home's occupants can be inferred from devices that were not originally intended to collector behavior information. For example, water flow sensors on a pipe can determine when the home is occupied and in some cases can identify which person is home. Other devices may to record conversations between people inside the home. The presence of these seemingly innocuous devices can lead to serious security or privacy leaks.

The new homeowner will want to know what devices are present, what is their function, and who has control over access to them. The last point is particularly salient for devices with obvious security and privacy implications (such as smart door locks and surveillance cameras), but is also important for devices with less obvious security and privacy implications as discussed above. The process of taking ownership of the new home, however, starts with detecting the presence of devices in the home.

In other scenarios, a user may have an interest in identifying electronic devices in other locations such as a hotel, office or conference room. Representative examples will be discussed herein in terms of a smart home, but one of ordinary skill in the art would understand that the principles disclosed may be applied to many different environments. The terms “reflected” and “re-radiated” are used interchangeably in the present disclosure.

Traditional radar transmits an RF signal toward a target. A portion of that signal is reflected or re-radiated from the outer portion or the encasing of the target. Assuming an otherwise empty environment, reflection indicates target detection and the time delay between TX (transmission) and RX (reception) is used to compute the range from the radar to the target. Traditional radar is linear; the set of frequencies reflected or re-radiated from the target is the same as frequencies transmitted, except for a slight difference imparted by relative motion between the target and the radar (the Doppler shift). These radars, however, are not well suited to detecting electronic devices in a cluttered environment such as a home, hotel room, or office. In those environments, the reflection of small electronics will be inter-mixed with reflections from walls, furniture, and people, and other obstacles. Detecting an electronic device, particularly if small and stationary, is extremely difficult due to the clutter and the motion of irrelevant objects.

Harmonic radar is a technology that may be used to discover all types of smart devices in a home-even those that are powered off. It may work irrespective of the device's communication protocols and should even detect malicious devices attempting to evade detection.

Various hardware devices are described herein, for example, signal generators, spectrum analyzers, filters, and antennas. These are representative examples to illustrate principles disclosed herein but other hardware implementations may be used.

### Harmonic Radar

A harmonic radar transmits a signal at a known frequency and listens for a return signal on a harmonic of the transmitted frequency (e.g., an integer multiple of the transmitted frequency). When the transmitted signal encounters a non-linear junction (common in electronic devices, see below), the non-linear junction reflects or re-radiates the transmitted signal at harmonic frequencies related to the transmitted signal. When the transmitted signal encounters obstacles that lack a non-linear junction, this reflection or re-radiation does not occur. This characteristic may be leveraged by transmitting on one or more frequencies while listening for reflections on a harmonic frequency of the transmit signal. A signal received at a harmonic frequency indicates the presence of a smart device.

Transistors are a basic component of modern electronic devices and are an example of a non-linear junction. Transistors are composed of semiconducting materials that are created by introducing impurities to the crystalline structure of different chemical elements (a process known as “doping”), particularly silicon. Using doping, transistors sandwich layers of n-type (negative type) silicon that have extra electrons, and p-type (positive type) silicon that have fewer electrons. This arrangement creates sharp, non-linear, junctions where different types of silicon meet. Diodes, amplifiers, mixers, and rectifiers are other examples of non-linear electronic components. These types of components are found in virtually all smart devices.

Man-made metal-to-metal junctions, such as the ones present in semiconductors or in oxidized metals, have the ability of transforming the received signal and generating a harmonic frequency. This is referred to as spectral regrowth. One of the possible responses is taking the incident radio waves and reflecting or re-radiating back a series of waves at harmonics of the original frequency.

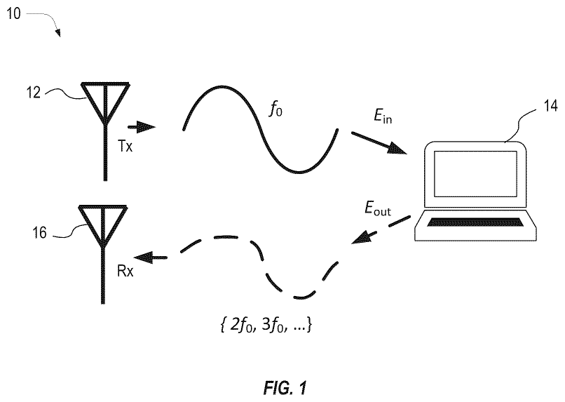

Detection and ranging technologies, illustrated schematically in FIG. 1, are systems 10 that combine a transmitter 12 that sends a signal ƒ₀ over some medium (often water or air), a target 14 that responds to the signal, and a receiver 16 that captures the response {2ƒ₀, 3ƒ₀, . . . }. The signal being transmitted may be affected by the transmission channel, obstacles in the signal's path, the target, and noise. Modeling and characterizing any of these systems typically involves finding the relationship between the outgoing and the incoming signal. Linear systems are homogeneous and follow the principle of superposition. Homogeneity refers to the scalar relationship between input and output, i.e., the transmitted signal and the return signal change proportionally with each other. Superposition is the sum of the individual elementary signals. Any system that is not homogeneous or for which superposition does not hold true is called a nonlinear system.

Junction points between two metals have a nonlinear response to radio signals. Harmonic radars are designed to capture the response emitted by electronic targets. The mathematical relationship between the transmitted signal and the response (generated by the junctions found in electronics) may be understood as a memoryless power series. A transmitted waveform may be a sinusoid of the form

$${E}_{Tx} = {E}_{0} cos ( {ω}_{0} f ) \qquad ( 1 )$$

where E_{Tx} is the electric field of the transmitted signal and E₀ is the amplitude of the electric field incident on the target (i.e., the received signal). The nonlinear response can be approximated by the power series

$${E}_{Rx} = {a}_{1} {E}_{Tx} + {a}_{2} {E}_{Tx}^{2} + {a}_{3} {E}_{Tx}^{3} + … \qquad ( 2 )$$

where α_{1,2,3}, . . . are the complex coefficients of the power series and E_{Rx} is the electric field reflected or re-radiated from the target. The nonlinear (harmonic) response may be expected to behave as follows:

$${E}_{Rx} = ( {a}_{1} {E}_{Tx} ) [ cos ( {ω}_{Tx} t ) ] + ( \frac{{a}_{2} {E}_{Tx}^{2}}{2} ) [ cos ( 2 {ω}_{Tx} t ) ] + ( \frac{{a}_{3} {E}_{Tx}^{3}}{4} ) [ cos ( 3 {ω}_{Tx} t ) ] + … \qquad ( 3 )$$

In eq. (3), ω_{Tx}=2πƒ_{Tx} and ƒ_{Tx} is the frequency of the probe (i.e., transmitted) signal.

The first term in the right side of eq. (3) is the linear response, as reflected or distorted by many objects in the radar's path. Metals, fluids, and construction materials (i.e., clutter) will either reflect, re-radiate, or attenuate the signal at this frequency. All subsequent terms (e.g., α₂, α₃) represent the electronic nonlinearity. As shown in FIG. 1, the sinusoid with frequency ƒ₀ (i.e., ƒ_{Tx}) is the only signal transmitted in the system. When ƒ₀ passes through a nonlinear target, it is reflected or re-radiated back at an integer multiple of the transmit frequency. Any signal present at the receiving antenna (Rx) listening on frequencies (2, 3, 4 . . . )×ƒ₀ confirms the presence of the target in the path.

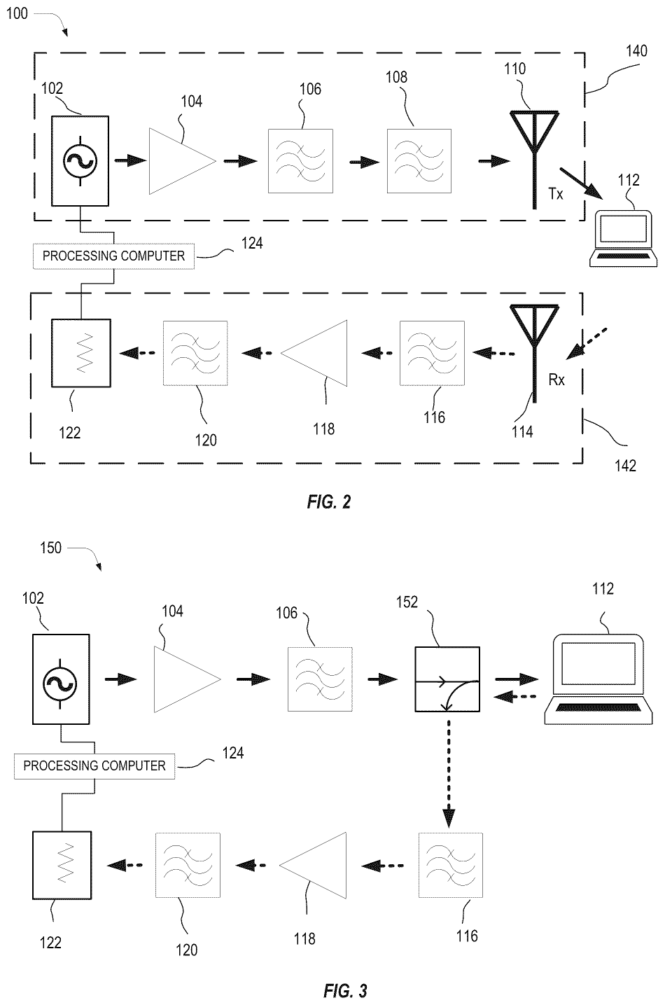

FIG. 2 is a block diagram of a representative wireless configuration of a harmonic radar system 100 for detecting electronic devices. The system may be viewed as including two blocks: a transmitter block (TX) 140 and receiver block (RX) 142. In embodiments, TX block 140 includes a tunable signal generator 102 with a frequency range between approximately 50 MHz and 6 GHz. RX block 142 includes spectrum analyzer 122. In embodiments, a range of spectrum analyzer is approximately 9 kHz to 6 GHz. Using a wide range for signal generator 102 and spectrum analyzer 122 gives the flexibility of using a wide variety of frequencies while still being able to capture the second harmonic. Both signal generator 102, such as a SignalHound VSG60A, and spectrum analyzer 122, for example, a SignalHound BB60C, are connected to a processing computer 124.

In embodiments, signal generator 102 is special purpose device that only generates a single frequency ƒ₀, and spectrum analyzer 122 is a special purpose device that only receives a single frequency 2ƒ₀.

Frequencies from signal generator 102 may be sent through power amplifier 104 to boost the signal strength. Optionally one or more low pass filters 106, 108 may be coupled to power amplifier 104 to remove any unwanted high frequency signals. In embodiments, power amplifier 104 is a Fairview Microwave SPA-030-3801-SMA which offers a 38 dBm gain over the input signal. The maximum power output by the VSG60A is 20 dBm (0.1 W). The power amplifier allows testing and adjusting the power level without saturating the signal generator. In embodiments, low pass filters 106 and 108 are MiniCircuits SLP-2950+ that transmit the base frequency while attenuating harmonics generated by signal generator 102. The clean output is transmitted toward a target smart device 112 by transmit antenna 110.

The transmitted frequency is reflected or re-radiated by target smart device 112 and detected by receive antenna 114, which is placed outside the radiation pattern of transmit antenna 110. In embodiments, transmit antenna 110 and receive antenna 114 are Ettus Research LP0965 log-periodic antennas. Receive antenna 114 may optionally be coupled to high-pass filters 116 to filter the lower frequency corresponding to the transmitted signal and transmit, if present, a harmonic signal. Amplifier 118 may boost the harmonic signal and may optionally be sent through a second high-pass filter 120 then to spectrum analyzer 122. In embodiments, high pass filters 116 and 120 may be a MiniCircuits VHF-3800+ that attenuate the base signal while allowing through any harmonic response. Power amplifier 118 may be a MiniCircuits ZX60-V63+.

The role of both filters and amplifiers is to strengthen and clean the signals, reducing the noise generated by the components in the circuit. Although representative circuitry has been identified for purposes of illustration, other circuits that provide equivalent processing may also be used. For example, signal generator 102 may generate a clean signal with no harmonics at an amplitude sufficient for detection, thus, amplifier 104 and low-pass filters 106 and 108 would not be necessary. Similarly, spectrum analyzer 122 may be capable of receiving and processing a signal from antenna 114 without the benefit of amplifier 118 and high-pass filters 116 and 120. In addition, more amplifiers and filters may be used than what is shown in FIG. 2.

FIG. 3 is a block diagram of a wired configuration of a harmonic radar system 20 for detecting electronic devices. FIG. 3 is similar to the wireless configuration of FIG. 2, but includes coupler 152, such as a MiniCircuit ZNDC-20-2GS+ on the return listening port. The three ports of coupler 152 connect transmitter, receiver, and target smart device 112; while allowing measurement of the transmitted signal after it had interacted with the test device.

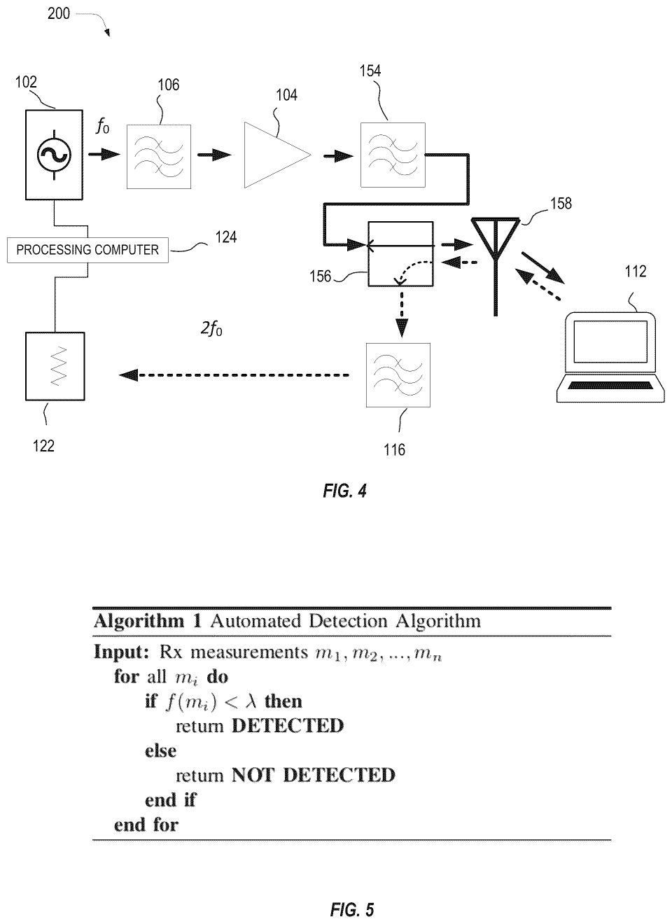

FIG. 4 is a block diagram of another harmonic radar system 200 for detecting electronic devices. The same reference numerals in different drawings represent the same or similar elements unless otherwise represented.

In embodiments, transmit antenna 110 and receive antenna 114 of FIG. 1 may be a single antenna connected to a coupler. As shown in FIG. 4, signal generator 102 generates a transmit signal ƒ₀. In embodiments, electronic device 112 exhibits the strongest harmonic response at a frequency at which electronic device 112 is designed to operate. Most IoT devices are designed to receive (RX) and transmit (TX) information at Wi-Fi or Bluetooth frequencies. Thus, transmit frequency ƒ₀ may be approximately 2.4 GHz.

On the TX path, signal generator 102 may be a SignalHound VSG60A signal generator capable of generating frequencies up to 6 GHz. Low pass filter 106, such as a MiniCircuits SLP-2950, may be coupled to signal generator 102 to remove harmonics of the transmie frequency. Next power amplifier 104, such as a Fairview SPA-030-38-01-SMA power amplifier, boosts the filtered signal. Bandpass filter 154, such as a Hewlett Packard HP 8430A bandpass filter again reduces unwanted signal components, this time induced by the power amplifier, before sending the signal to coupler 156, such as a MiniCircuits ZUDC10-83-S+ coupler, and ultimately to antenna 158, such as an Ettus Research LP0965 log-periodic antenna for transmission.

On the RX path, antenna 158 receives any harmonics reflected or re-radiated by electronic device 112 and passes them to the Mini-Circuits ZUDC10-83-S+ coupler 156. In embodiments, system 200 is designed to detect signals at 2ƒ₀, so high pass filter 116, such as a HP 8435A high-pass filter, reduces the base frequency ƒ₀ before the harmonic signal reaches spectrum analyzer 122. Like harmonic radar system 100 of FIG. 2, fewer or more amplifiers and filters may be used in the harmonic radar systems of FIGS. 3 and 4.

Although representative frequencies have been discussed, this is for purposes of illustration and other frequencies may be used by harmonic radar systems 100, 150, and 200. In general, the choice of frequency is often tied to the range of the radar. For detection of devices within a home or small building, the range of less than 100 meters allows more flexibility in the choice of transmit frequency. Furthermore, because of RF noise regulations and shielding material built into their design, target electronic devices are more likely to generate harmonics at frequencies they are intended to operate. As many consumer, smart home, and IoT devices operate within the S-Band range (i.e., Wi-Fi, Zigbee, Bluetooth), embodiments disclosed herein detect harmonics in a range of 4-8 GHZ.

### Device Detection

A design criteria for a harmonic radar system is transmitting a signal strong enough so that the lower power harmonics are detectable by the receiving antenna. Several factors are considered when choosing a signal generator for use in a harmonic radar system. First, the maximum power output of signal generator 102 may be much lower than the level necessary to receive a detectable harmonic. As disclosed herein, signal generator 102 may have a maximum power output of 20 dBm, which is the equivalent of 100 mW. This limitation is compensated for by the addition of power amplifier 104 to the transmission line so that a strong harmonic-free signal is transmitted from the outgoing channel. Another consideration is that components of the RF circuit for generating and measuring the signals are electronic devices in their own right. RF noise leaks will interact with devices and generate harmonics at the same range as electronic device 112. This limitation may be addressed by extracting a low-power signal close to the noise floor of spectrum analyzer 122 by adding one or both of low-pass filters 106 and 108 to TX block 140 (i.e., attenuating any harmonics generated by the system) and adding one or both of high-pass filters 106 and 120 to RX block 142 (i.e., attenuating the linear response).

While filters reduce (or eliminate) false positives by cleaning the signals, embodiments of harmonic radar systems disclosed herein (e.g., systems 100, 150, 200, 300) may be enhanced when the amplifier 118 boosts the received signal to a level where the analog-to-digital converter in spectrum analyzer 122 captures information contained at 2ƒ₀. In such embodiments, amplifier 118 may be a low-noise amplifier.

In free space, the harmonic power received from a nonlinear target is mathematically modeled by a modified version of the classical Friis transmission equation for a radar whose transmitter and receiver are co-located. This nonlinear Radar Cross Section equation is given by

$${P}_{RX} = ( {G}_{RX} {{λ}^{2} ( {P}_{TX} {G}_{TX} )}^{2} σ ) / ( {( 4 π )}^{4} {R}^{6} ) . \qquad ( 4 )$$

In Equation (4), TX identifies the transmitter and RX the receiver, P indicates power, G is the gain at the antennas, λ is the fundamental (or base) frequency wavelength, R is the distance to the target device, and σ is the radar cross-section of the target device. In this situation, radar cross-section σ may be considered a conversion loss between the transmitted probe frequency and the harmonic generated by the target device.

It should be noted that Equation (4) holds for a first-harmonic interaction, i.e., assuming that only the squared term from Equation (2) is retained. For higher-order interactions (i.e., higher harmonics), require tuning the receiver to higher frequencies.

Mathematically, responses from nonlinear targets are typically very weak because values for σ commonly range from 10⁻⁸ to 10⁻⁵ m⁴/W. Power incident on the target falls off with distance away from the transmitter, according to the one-way (linear) Friis equation, by a factor of R². This incident power is then squared by the power-series law of Equation (2) giving R⁴ and multiplied by the other terms in Equation (4) including σ. With the transmitter and receiver co-located, power captured by the receiver also falls off with distance away from the target by R², which when multiplied by the R⁴ gives the theoretical R⁶.

In a practical scenario, the received signal will be further reduced by effects such as multipath (multiple signal reverberations between the target and the receiver) and obscuring/shadowing of the target by walls, furniture, appliances, or other obstacles. Because the typical values for σ are so small, the power transmitted by a harmonic radar generally may be orders-of-magnitude higher than a traditional (linear) radar to achieve a comparable signal-to-noise ratio. This disadvantage, however, trades off against the chief advantage of harmonic radar, which is clutter rejection.

Electronics generate harmonics; nearly all other materials and devices do not. Some electronic devices (e.g., smart switches, buzzers, calculators) are so small that they appear to traditional radar as noise or (at best) weak clutter items. However, even at distances of meters are more, electronics smaller than 1 cm are still detectable using harmonic radar. In other words, though the power required to achieve practical detection distances for harmonic radar is high (i.e., Watts or more), this type of radar has the ability to detect electronic targets that would otherwise be undetectable by traditional radar. In embodiments disclosed herein, the targets are not obscured, the antennas are co-located, and there is a direct line-of-sight between the targets and the antennas. Thus, following Equation (4), the harmonic responses received from nonlinear targets are expected to fall as 1/R⁶ as the distance between TX/RX antennas and the electronic devices increases.

RF measurements, such as those collected with a harmonic radar system, contain background signals from the environment and system-generated noise created by the radar's hardware components. Systems disclosed herein account for and mitigate each type of noise. Environmental noise may be measured by pointing antennas at an open space with no target device present. In embodiments, a typical environmental noise measurement would show random noise above a noise floor as a response to a transmitted signal.

A harmonic radar system (e.g., system 100, 150, 200, or 300) may also account for system-generated noise by capturing the response of the system with a target electronic device. In embodiments, signal generator 102 produces a transmit signal that includes a sequence of pulses. In such embodiments, a typical response may show a one-to-one correspondence with the transmitted signal followed by environmental noise.

To further evaluate system-generated noise, the target device may be replaced with a cardboard box of the same size and shape as the target device. If the radar's hardware components have successfully filtered all system-generated noise, the output results would be expected to be similar to those shown when measuring environmental noise, because the cardboard box contains no nonlinear elements. Although embodiments disclosed herein use several filters to eliminate noise from hardware components, there may still some leakage at 2ƒ₀ that is transmitted towards a target. The transmit path (i.e., the components between the signal generator and the antenna) are electronic and have nonlinearities. Low pass filters (e.g., filters 106 and/or 108) may be used to attenuate and ideally eliminate any high-frequency components in the transmit signal. However, it is likely that a non-negligible portion is transmitted.

For accurate detection, a harmonic signal returned from an electronic device 112 is separable from noise. To differentiate between noise and signal, the mean x̅ and standard deviation s may be computed for the environmental noise data comprised of many RX measurements collected while the system was not transmitting. Then, the standard error of the mean ox can be calculated, which may show that x is within one percent of the true mean u. These measurements can be used to represent the environmental noise as a normal distribution with probability density ƒ(z|x̅, s²).

To address the system-generated noise, the environmental noise may be corrected with a translation in the y axis. Readings collected from one dummy device (e.g., the cardboard box) may be used as a reference. This approximates the shift in the environmental noise distribution by the arithmetic mean of one dummy target.

After correcting the distribution for the system-generated noise, the noise measurements satisfy ƒ(z)≥λ=0.0377, where λ is the probability density at the boundary of the selected confidence interval (95%)—can be used as threshold. Given any RX measurement m, it is highly probable that a target is present when ƒ(m)<λ. Algorithm 1 as depicted in FIG. 5 shows a method for detection, but other algorithms may be used.

One thing to note is that since λ is dependent on the confidence level, it can serve as a “sensitivity gauge”. Selecting a lower confidence level (i.e., higher λ), increases the detection range at the cost of also increasing the number of false positives. Thus, the trade-offs should be evaluated before selecting an appropriate λ.

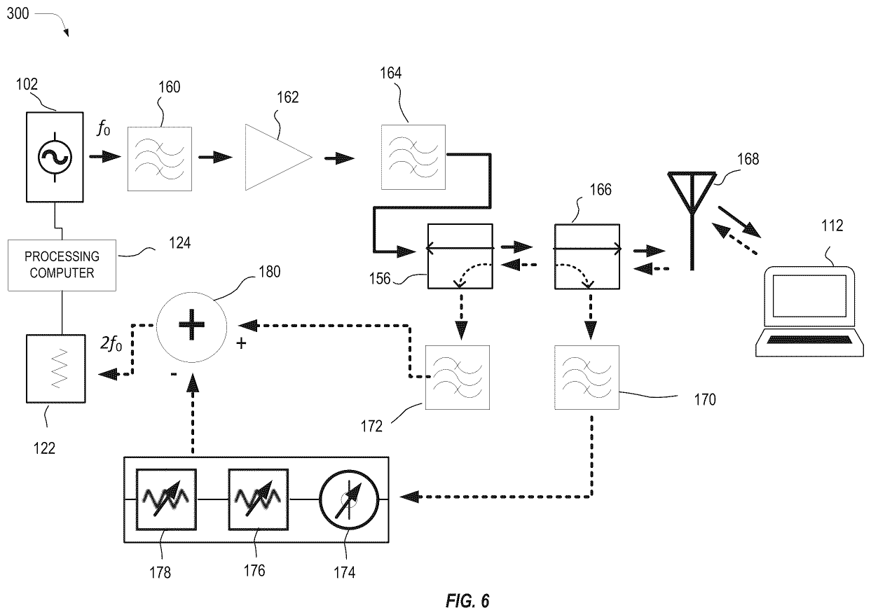

FIG. 6 is a block diagram of a harmonic radar system 300 for detecting an electronic device in an environment that includes multi-path reflections and interference from other signals at and around the transmit frequency. System 300 is similar to system 200 of FIG. 4, and the same reference numerals represent the same or similar elements unless otherwise represented.

On the TX path, signal generator 102 may be capable of generating multiple frequencies. Low pass filter 160, such as a MiniCircuits SLP-1000+, then reduces harmonics created by signal generator 102. Next power amplifier 162 boosts the filtered signal. In contrast to system 200, power amplifier 162 may be a MiniCircuits ZHL-20W-13+ has a gain of approximately 50 dB (compared to the 37 dBm of the SPA-030-38-01). Bandpass filter 164, such as a MiniCircuits SLP-1000+, again reduces unwanted signal components, this time induced by power amplifier 162, before sending the signal to a series of couplers 156 and 166, such as a MiniCircuits ZUDC10⁻⁸³-S+ coupler and ultimately to antenna 168 for transmission.

Maintaining a clean signal at this power was facilitated by the addition of the negative feedback loop composed of two couplers 156 and 166, variable attenuators 176 and 178, and a phase shifter 174. In this setup, the harmonics generated by the nonlinear components of the system cancel themselves out by shifting the phase of the noise signal and adding it through the feedback loop creating destructive interference. On the RX path, antenna 168 receives any harmonics reflected or re-radiated by electronic device 112 and passes them to coupler 166. The negative feedback loop includes high pass filter 170, such as a MiniCircuits VHF-1200+, where a transmitted harmonic functions as a cancellation signal when sent through phase shifter 174, such as Narda 3752, variable attenuator 176, such as Texscan MA-211, and variable attenuator 178, such as Telonic 8052S to frequency combiner 180, such as MiniCircuits ZFR SC-42-S+. The reflected or re-radiated signal from target electronic device 112 is also sent back through coupler 166 to coupler 156 and then to high pass filter 172, such as a MiniCircuits VHF-1200+, so that the target response and the transmitted harmonic are sent to another input of frequency combiner 180, where the sum is sent to spectrum analyzer 122.

### Device Identification

The harmonic response of target electronic devices 112 may be identified and quantified so that consumer-grade electronic device may be reliably detected and categorized, even if the devices are powered off or attempt to evade detection. Devices generally exhibit a stronger harmonic response at frequencies in which the device is designed to operate. In embodiments, the electronic devices 112 are personal electronics and smart home devices, most of which are Wi-Fi enabled. This type of device may be expected to respond at or around 2.4 GHz.

In embodiments, the harmonic radar systems disclosed herein may not only detect the presence of smart devices, but also identify the devices from a known set of devices and detect the presence of previously unseen devices.

As explained above, electronic devices distort transmitted radio frequencies before reflecting off or re-radiating from them. Detecting and analyzing the harmonic response to a transmitted RF contains enough information to infer the type of device that re-radiated or reflected the transmitted RF. This type of detection may work when the device has no wireless network interface, is powered off, or attempts to evade detection.

Every type and model of electronic device has a different set of components, in a different configuration. Consumer devices are also encased and shielded to limit RF leaks and RF interference; this shielding affects the way the device will receive and respond to an incident radar signal. If a device has an antenna, the natural path for reflecting the harmonics of a received tone is through the antenna; the geometry and design of each circuit determines the radiation pattern of re-radiated signals. These physical differences among devices-perhaps even between devices of identical make and model-lead to distinctive responses to a harmonic radar, allowing devices to be distinguished by a classifier trained to recognize these ‘fingerprints’.

Various approaches may be used for device identification using the harmonic radar systems disclosed herein. One approach transmits a single tone (frequency) and listens for a response at the first harmonic (e.g., two times the transmitted frequency). Another approach sweeps a single tone over a range of frequencies while listening at two times each transmitted frequency. Yet another approach transmits two tones simultaneously, purposely generating intermodulation distortion, and listens over a range of frequencies.

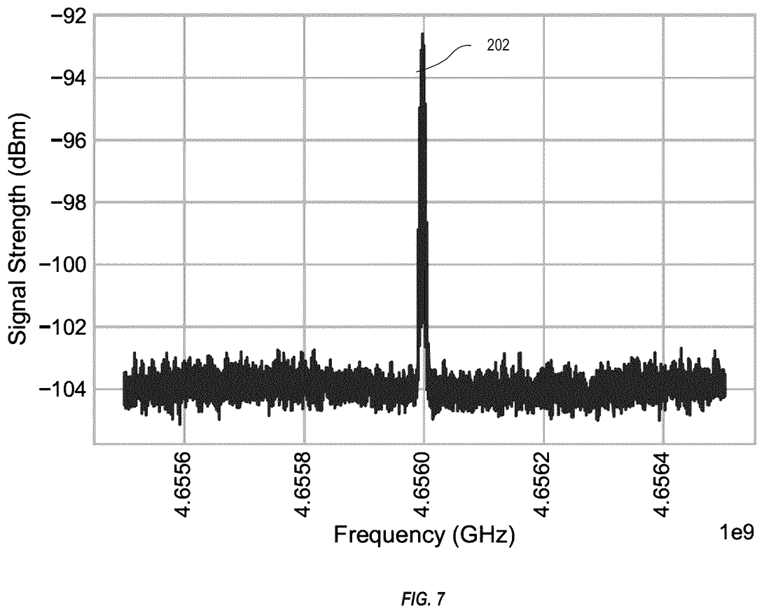

In a single tone approach, signal generator 102 transmits a single tone, at 2.328 GHz, for example. This frequency may be used because it is close to the operating frequency of many Wi-Fi and Bluetooth devices and because devices tend to respond well at this frequency. However, other tones could be used. For tones at this frequency, the response at the first harmonic of 4.656 GHz is measured by spectrum analyzer 122. FIG. 7 is a graph showing a representative response of a device to a series of signals collected over a 1 MHz window centered on the first harmonic of the 2.328 GHz transmitted signal. A spike 202 appears at the harmonic frequency. Other devices with different nonlinear electrical components within each device may have graphs showing a spike at the same frequency but with different amplitudes.

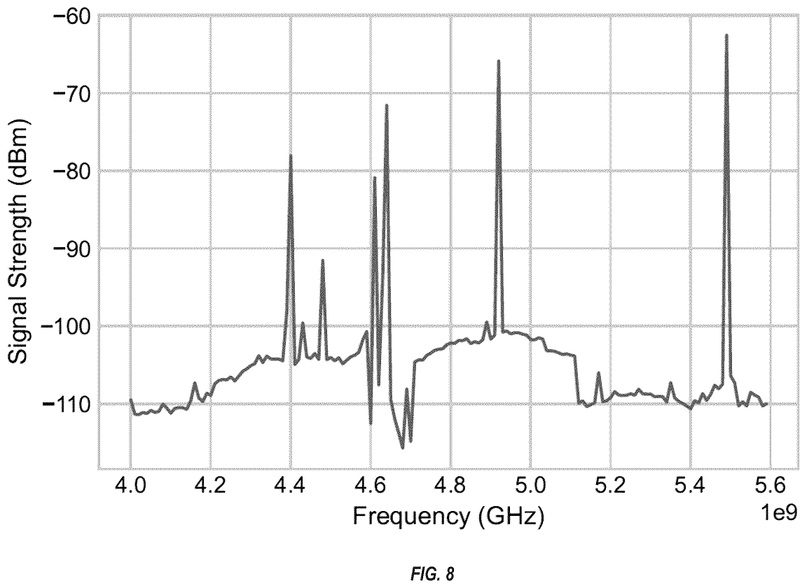

In a swept range of tones approach, signal generator 102 of a harmonic radar system disclosed herein (system 100, 150, 200, 300) steps through a sequence of tones from 2.0 GHz to 2.8 GHz, in 10 MHz increments, for example. At each step it transmits a single tone, pauses, then the system listens for a response at the corresponding first harmonic (from 4.0 GHZ to 5.6 GHZ). In an example embodiment using a swept range of tones, probe signals with frequencies in a series of steps are used. For example, a tone every 10 MHz from 2.0-2.8 GHz is transmitted towards a target device. The response is collected, one at a time, at the first harmonic of each transmitted frequency (i.e., 2ƒ₀). Due to the variation in composition of different devices, the harmonic frequency response also varies between devices as shown in FIG. 8. The more unique harmonic frequency responses allow identification of devices with an accuracy of 0.976, because the use of a wide range of transmit frequencies generates a distinct fingerprint across devices.

In the simultaneous tones approach, two tones are transmitted simultaneously, purposefully creating intermodulation distortion (IMD), that is, signals with multiple tones on the same wave. Specifically it creates mixing products (in addition to the normal harmonics) at 2ω1−ω2 and 2ω2−ω1. The system measures the response over the mixing products of the tones.

In this approach, only two tones with a commonly used spacing of 1 MHZ between the two frequencies are used to generate the cross-modulated harmonics. Here, the limiting factor is the signal-to-noise ratio of the response. Compared to the power of the reflected or re-radiated signal of a single-tone harmonic, the reflection of each tone in a multi-tone signal is scaled down by a factor proportional to the number of tones. In other words, by transmitting more than one tone (but the same total power) the power of the response of the single-tone harmonic gets distributed across all transmitted (and thus received) frequencies.

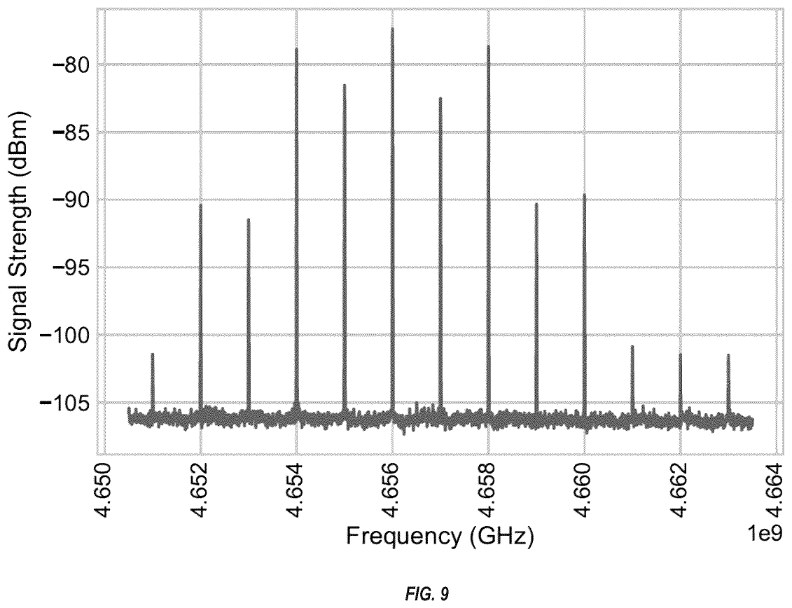

In an example embodiment, two simultaneous frequencies at 2.328 GHZ±1 MHZ are transmitted toward a target device. When two narrow tones are transmitted simultaneously, the plot of harmonic response as shown in FIG. 9 shows a spike at the harmonic of each tone and the mixing product of both tones.

For each approach, a harmonic radar system disclosed herein may transmit a signal toward a target device in N sessions and listen on the first harmonic of the transmitted signal. N is a positive integer, e.g., N=10. In embodiments, processing computer 124 may perform N-fold cross validation by creating classifiers repeatedly using (N−1) sessions as training data and evaluating the system on the N^{th} session. In some embodiments, the orientation of the device relative to transmit antenna 110 and receive antenna 114 is fixed. In other embodiments, the orientation may vary and may not be known to the harmonic radar system.

In embodiments, results may be computed. e.g., by processing computer 124, using one or more of several classifiers (e.g., random forests, support vector machines, and gradient boost algorithms). In a further embodiment, random forests are used to compute results. The configuration parameters for the random forest may be selected through a grid search and ultimately, each forest includes multiple estimators (e.g., 300) with a maximum depth of 90 and at least 5 samples per leaf.

In embodiments, the most accurate approach for identification appears to be the response from a swept range of tones. In a real-world deployment, however, it may not always be possible to probe a device at the same orientation angle for which the classifier was trained. Indeed it is unlikely the device will be in the same orientation in the field. The simplest solution is to scan a device from multiple angles during training (building a more robust fingerprint from different perspectives).

### Detecting Unknown Devices

In a further example embodiment, unknown devices may be identified from a set of devices. There are many contexts where it may be important to determine, e.g., with processing computer 124, whether the device being tested belongs to the set of ‘known’ devices, i.e., to discover the arrival of a new device that needs to be added to the known inventory, or to determine whether the new device may have been placed (or replaced) by an adversary. This is a binary classification task where each device is labeled either as ‘known’ or ‘unknown’. Unknown devices may be detected by creating a two-stage classifier; in the first stage, the classifier outputs a probability of a target device being in each one of the N ‘known’ classes; in the second stage, the classifier outputs ‘known’ if the probability for the output class is above a predetermined threshold, and ‘unknown’ if no class achieves that threshold probability. N is a positive integer.

For this scenario, the multi-class classifier is trained by excluding one device at a time. All examples of the excluded device and four of the ten measurements for the remaining devices are included in the testing set. Finally, this process may be repeated for all devices and the results are aggregated. Because of the imbalance of the classes in the testing set, the balanced accuracy may be computed for all test observations rather than accuracy.

Harmonic radar systems disclosed herein may be used as part of an inspection during a home sale, similar to a structural engineer's examination of the home's integrity. In the device inspection, the harmonic radar system may sweep the home to inventory all electronic devices, even hidden devices. This inventory might include the device type and its location within the home. This inventory can allow the seller to ensure they have removed any personal information from the devices left behind and can allow the buyer to take control of (or change) any device credentials, such as passwords or cryptographic keys.

In other embodiments, harmonic radar systems disclosed herein may be handheld and designed sweep temporary quarters such as hotel rooms or rental homes for hidden cameras or microphones. Further, a stationary harmonic radar system may be deployed to discover all electronic devices present in a home. Such a system may have two characteristics: (1) enough range to cover the whole home (and possibly other areas such as a garage or outside deck), and (2) the ability to differentiate devices at different angles and distances from the harmonic radar.

Changes may be made in the above methods and systems without departing from the scope hereof. For example, in future works, different waveforms may be used to increase either the range or the performance of the radar. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A harmonic radar system for detecting an electronic device, comprising:
a signal generator that generates one or more transmit radio frequency (RF) signals;
a transmitting antenna for sending the transmit RF signals into an environment;
a receiving antenna for receiving signals re-radiated by the electronic device in the environment in response to the transmit RF signals; and
a spectrum analyzer for identifying a harmonic frequency of the transmit RF signals in the received signals.

2. The harmonic radar system of claim 1, further comprising one or more low-pass filters for removing harmonics from the transmit RF signals coupled between the signal generator and the transmitting antenna.

3. The harmonic radar system of claim 2, further comprising a transmitting amplifier coupled between the signal generator and the one or more low-pass filters.

4. The harmonic radar system of claim 1, further comprising one or more high-pass filters for filtering the received signals coupled between the receiving antenna and the spectrum analyzer.

5. The harmonic radar system of claim 4, further comprising a receiving amplifier.

6. The harmonic radar system of claim 1, wherein the signal generator is tunable to generate signals between approximately 9 kHz and 6 GHz.

7. The harmonic radar system of claim 6, wherein the signal generator generates a signal at ƒ₀.

8. The harmonic radar system of claim 7, wherein the spectrum analyzer has a frequency range of approximately 2ƒ₀.

9. The harmonic radar system of claim 1, wherein a center frequency of one or more transmit RF signals is approximately ƒ₀=2.4 GHz.

10. The harmonic radar system of claim 1, further comprising a processing computer coupled to the signal generator and spectrum analyzer.

11. A harmonic radar system for detecting an electronic device, comprising:
a signal generator that generates a transmit radio frequency (RF) signal;
a coupler for receiving the transmit RF signal;
an antenna for (i) transmitting the transmit RF signal from the coupler into an environment including the electronic device and (ii) receiving signals re-radiated by the electronic device in response to the transmit RF signals and sending them to the coupler; and
a spectrum analyzer for identifying a harmonic frequency of the transmit RF signals in the received signals.

12. The harmonic radar system of claim 11, further comprising, coupled between the signal generator and the coupler, an amplifier and one or more low-pass filters for removing harmonic frequencies in the transmit RF signal.

13. The harmonic radar system of claim 11, further comprising, coupled between the antenna and the spectrum analyzer, one or more high-pass filters for filtering the received signals.

14. The harmonic radar system of claim 11, further comprising a processing computer coupled to the signal generator and spectrum analyzer.

15. A method of using a harmonic radar system for detecting an electronic device, comprising:
generating a transmit radio frequency (RF) signal;
transmitting the transmit RF signal into an environment including the electronic device;
receiving a signal re-radiated by the electronic device in response to the transmit RF signal;
removing environmental and system-generated noise from received signal; and
identifying a harmonic frequency of the transmit RF signal in the received signal.

16. The method of claim 15, wherein the transmit RF signal comprises a single tone.

17. The method of claim 15, wherein the transmit RF signal comprises a swept range of tones.

18. The method of claim 15, wherein the transmit RF signal comprises multiple simultaneous tones.

19. The method of claim 15, wherein a center frequency of one or more transmit RF signals is approximately ƒ₀=2.4 GHz.

20. The method of claim 19, wherein the identified harmonic frequency is 2ƒ₀.
